(19) United States
(12) Patent Application Publication
(10) Pub. No.: US 2022/0065034 A1
(43) Pub. Date: Mar. 3, 2022

(54) SCROLLING UNIT FOR ELECTRIC WINDOW CURTAIN

(71) Applicant: Wen Ying LIANG, Changhua County (TW)

(72) Inventor: Wen Ying LIANG, Changhua County (TW)

(73) Assignee: CHING FENG HOME FASHIONS CO., LTD., Changhua County (TW)

(21) Appl. No.: 17/382,210

(22) Filed: Jul. 21, 2021

(30) Foreign Application Priority Data
Sep. 3, 2020 (TW) 109211528
Mar. 8, 2021 (TW) 110202422

(51) Int. Cl. E06B 9/322; E06B 9/262

(52) U.S. Cl. CPC E06B 9/322; E06B 2009/3225; E06B 2009/2622; E06B 9/262

(57) ABSTRACT

A window curtain includes a top rail, a bottom rail and a curtain between the top and bottom rails. A transmission unit and a scrolling unit are received in the bottom rail. Transmission unit includes a control member, a motor, and a shaft connected to the motor. The scrolling unit includes a case in which a passive part, a first prat and a second part are accommodated. The shaft of the motor drives the scrolling unit. A first rope is connected to the first part. A second rope is connected to the second part. The first and second ropes pass through the curtain and are connected to the top rail via the first and second transition members. The transmission unit and the scrolling unit are received in the bottom rail to reduce the weight of the top rail, and are easily maintained.

### BACKGROUND OF THE INVENTION

### 1. Fields of the Invention

The present invention relates to an electric window curtain, and more particularly, to a scrolling unit of an electric window curtain.

### 2. Descriptions of Related Art

Electric window curtains have become very popular in recent years. Not only are there no ropes to prevent accidents, but also the curtains can be opened or closed through electronic control.

Most of the transmission devices of electric window curtains are installed in the top rail of the electric curtain. However, there could be no room for assembly of the top rail that may occupies a certain room because the transmission device received in the top rail. In addition, the transmission device in the top rail, it requires equipment to support the parts when installing, and this may cause inconvenience maintenance in the feature.

Most of the electric window curtains use a motor to drive the shaft to operate the ropes. When the curtain is blocked by objects, it causes uneven release of the rope, which may further cause the ropes to be entangled and knotted.

The present invention intends to provide a scrolling unit of an electric window curtain to ensure that the curtain is smoothly operated and to eliminate the shortcomings mentioned above.

### SUMMARY OF THE INVENTION

The present invention relates to a window curtain and comprises a top rail, a bottom rail, a curtain connected between the top rail and the bottom rail, a transmission unit and a scrolling unit. The transmission unit and the scrolling unit are both located in the bottom rail. The transmission unit includes a control member, a motor and a shaft connected to the motor. The control member controls operation of the motor. The scrolling unit includes a case in which a passive part, a first prat and a second part are accommodated. The passive part includes a bevel gear and a spur gear which is co-rotated with the bevel gear. The shaft extends into the case and is connected to a driving gear which is engaged with the bevel gear. The first part includes at least one first gear, a first spool and a first rope. The at least one first gear is engaged with the spur gear. The first rope is wrapped to the first spool. An end of the first rope passes through a first transition member and the curtain, and is fixed to the first end of the top rail. The second part includes at least one second gear, a second spool and a second rope. The at least one second gear is engaged with the at least one first gear. The second rope is wrapped to the second spool. An end of the second rope passes through a second transition member and the curtain, and is fixed to the second end of the top rail.

The first transition member and the second transition member are respectively located to two ends of the bottom rail. The first transition member and the second transition member have identical structure and located symmetrically to each other. Each of the first transition member and the second transition member includes a first rod and a second rod, wherein the first rod is perpendicular to the bottom rail, and the second rod is parallel to the bottom rail. The first/second rope are wrapped to the first rod and turn 90 degrees to be wrapped to the second rod. The first/second rope then passes through the curtain and is fixed to the top rail.

Preferably, the transmission unit includes a power supply which is electrically connected to the motor.

Preferably, the power supply includes a box and a rechargeable battery is received in the box.

Preferably, the control member of the transmission unit is controlled by a wireless remote controller so as to activate the motor.

Preferably, the bottom rail includes a bottom pate and a housing. The bottom plate is connected to the housing to form a room between the housing and the bottom plate. The transmission unit, the scrolling unit, the first transition member, the second transition member are located in the room between of the housing and the bottom plate.

The advantages of the present invention are that the transmission unit, the scrolling unit, the first transition member and the second transition member are located in the bottom rail so that the weight of the top rail is reduced. The transmission unit and the scrolling unit are easily maintained.

The electric window curtain can be operated by the battery even when an electric power outage happens.

The transmission unit is located in the bottom rail, so that the replacement of the battery is easy and convenient.

The scrolling unit is transversely installed so that the ropes are not likely entangled with each other.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the electric window curtain of the present invention;

FIG. 2 is an exploded view of the electric window curtain of the present invention;

FIG. 2A is an enlarged view to show the transition member;

FIG. 3 is a perspective view to show the scrolling unit of the present invention;

FIG. 4 is an exploded view to show the scrolling unit of the present invention;

FIG. 5 shows that the scrolling unit releases the ropes to lower the curtain;

FIG. 6 shows that the scrolling unit wraps the ropes to lift the curtain;

FIG. 7 shows the power supply of the present invention, and

FIG. 8 shows that the power supply is electrically connected to the motor.

### DETAILED DESCRIPTION OF THE PREFERRED EMBODIMENT

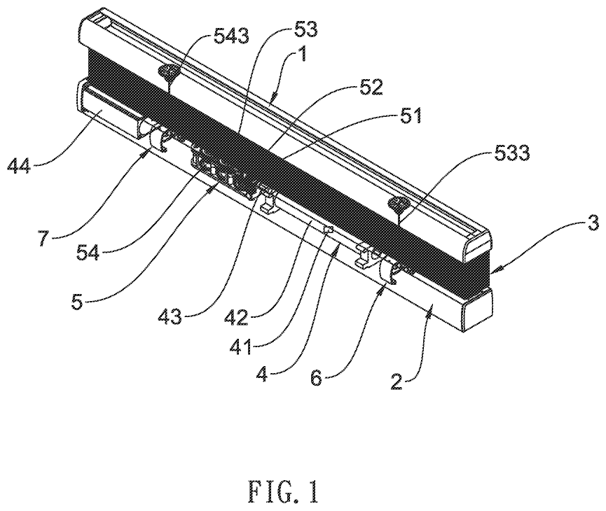

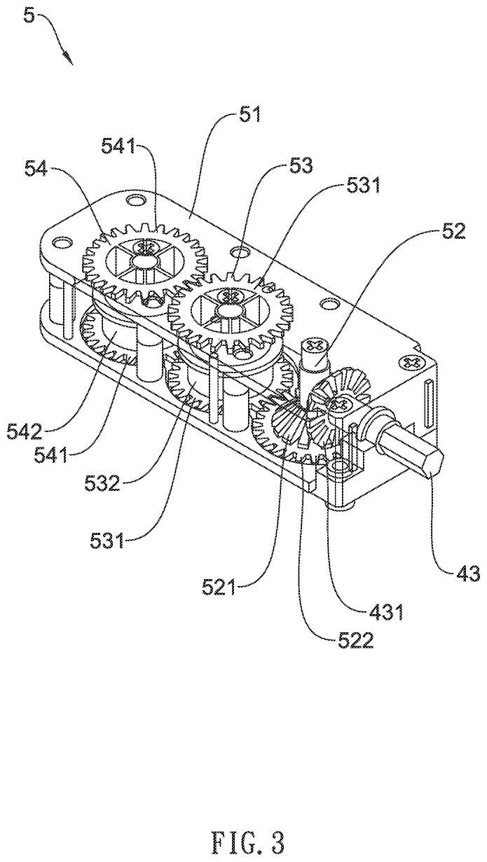

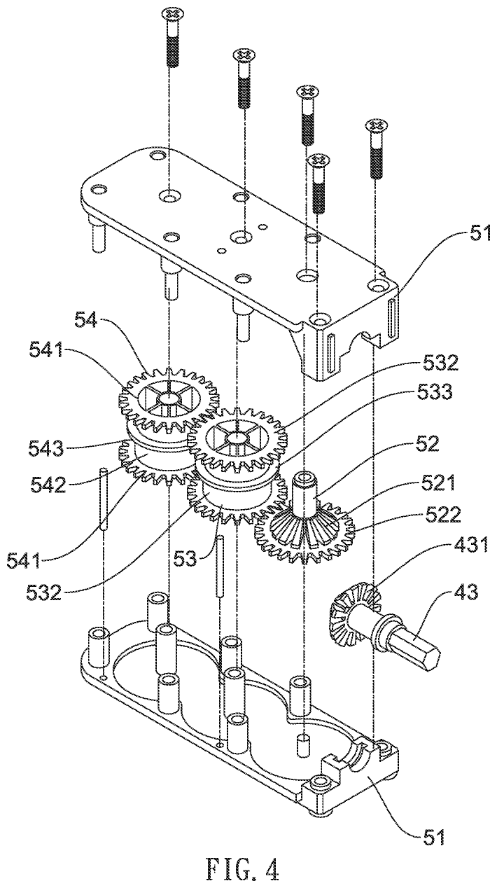

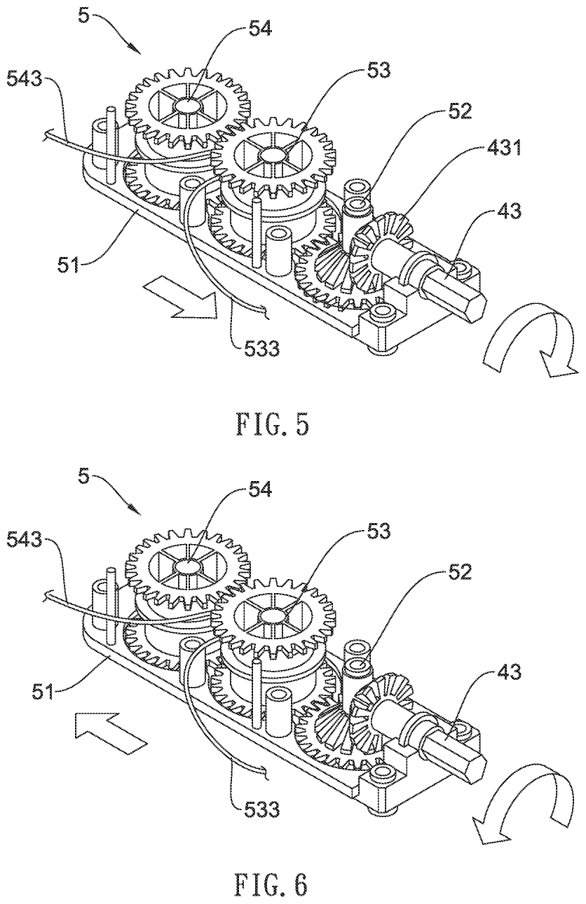

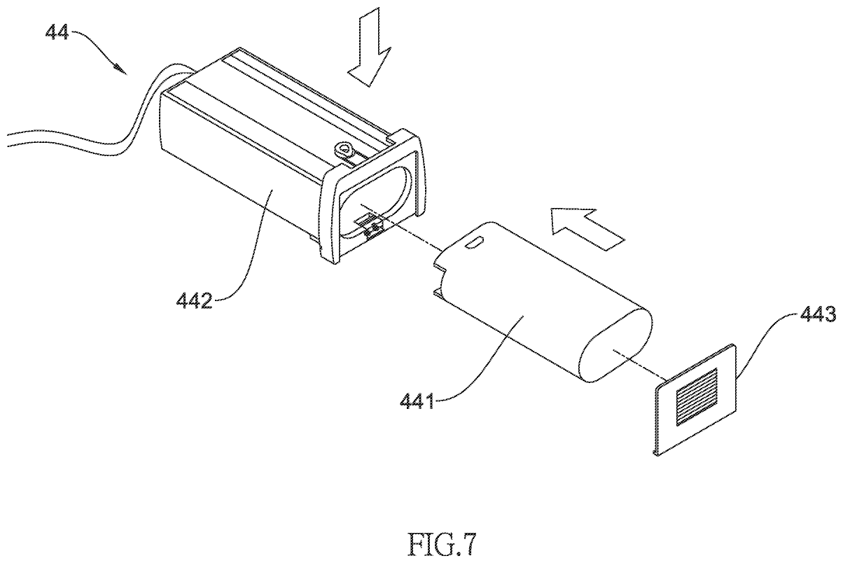

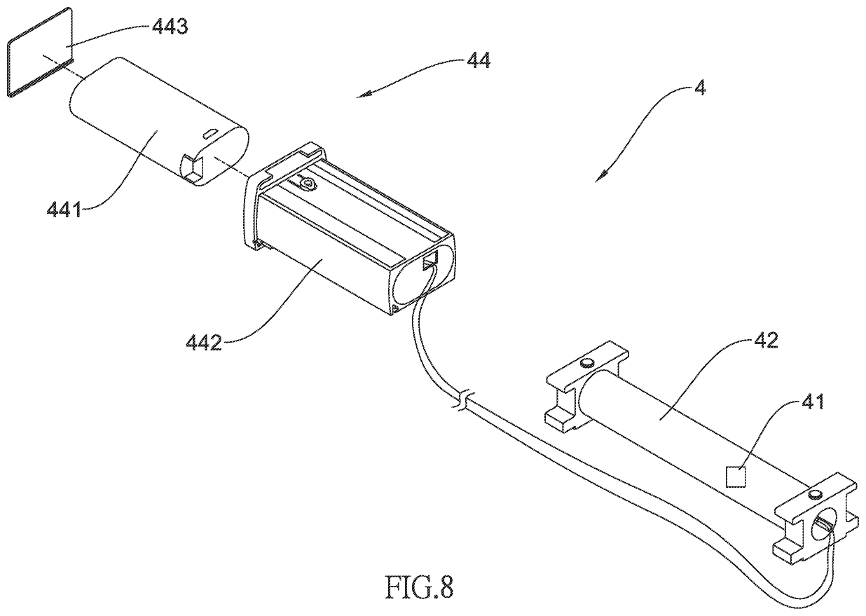

Referring to FIGS. 1 to 8, the electric window curtain of the present invention comprises a top rail 1, a bottom rail 2, a curtain 3 connected between the top rail 1 and the bottom rail 2, a transmission unit 4, a scrolling unit 5, a first transition member 6 and a second transition member 7.

The top rail 1 includes a U-shaped cross section and connected to the top edge of a window. The transmission unit 4, the scrolling unit 5, the first transition member 6 and the second transition member 7 are received in the bottom rail 2 so that the top rail 1 is easily installed. The transmission unit 4 and the scrolling unit 5 lift or lower the curtain 3.

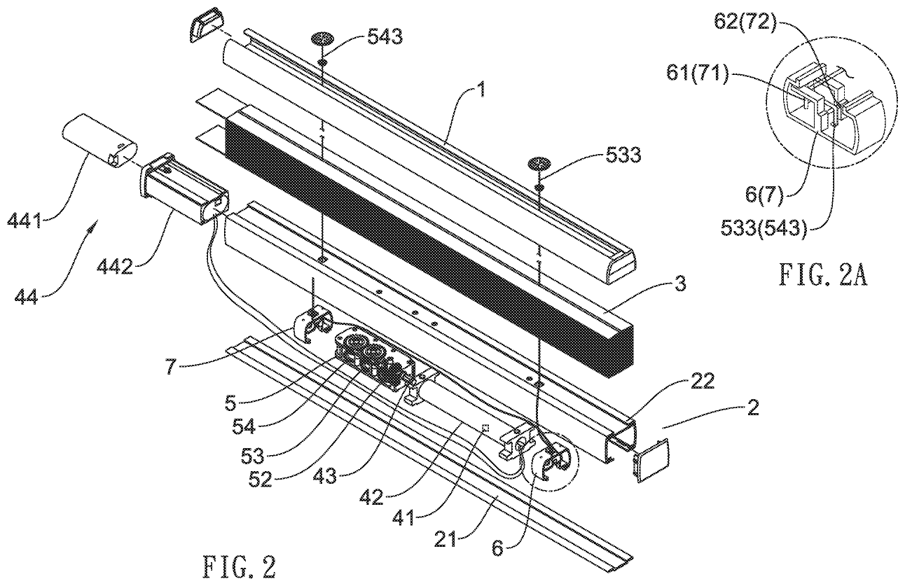

As shown in FIGS. 1 and 2, the bottom rail 2 includes a bottom plate 21 and a housing 22. The bottom pate 21 is connected to the housing 22 to form a room between the housing 22 and the bottom plate 21. The transmission unit 4, the scrolling unit 5, the first transition member 6 and the second transition member 7 are located in the room between of the housing 22 and the bottom plate 21.

The curtain 3 can be a comb-shaped curtain in this embodiment, other types of curtains can also be used, such as blinds or Roman shade.

As shown in FIGS. 2, 7 and 8, the transmission unit 4 includes a control member 41, a motor 42 and a shaft 43. The shaft 43 is connected to the motor 42. The control member 41 controls operation of the motor 42, such as number of revolutions and rotational directions. The shaft 43 of the motor 42 is connected to the scrolling unit 5. The transmission unit 4 includes a power supply 44 which is electrically connected to the motor 42. The power supply 44 includes a box 442 and a rechargeable battery 441 is received in the box 442. A cover 443 is connected to the box 42 to accommodate the re rechargeable battery 441 in the box 442. When an electric power outage happens, the curtain 3 can also be operated by the power from the rechargeable battery 441.

As shown in FIGS. 2 to 6, the scrolling unit 5 located in the bottom rail 2 and includes a case 51 in which a passive part 52, a first prat 53 and a second part 54 are accommodated. The passive part 52 includes a bevel gear 521 and a spur gear 522 which is co-rotated with the bevel gear 521. The shaft 43 extends into the case 51 and is connected to a driving gear 431. The driving gear 431 is engaged with the bevel gear 521, and the spur gear 522 is located beneath the bevel gear 521.

The first part 53 including at least one first gear 531, a first spool 532 and a first rope 533. The at least one first gear 531 is engaged with the spur gear 522. One of two ends of the first rope 533 is wrapped to the first spool 532, the other one of the two ends of the first rope 522 passes through the first transition member 6 and the curtain 3, and is fixed to the first end of the top rail 1.

The second part 54 includes at least one second gear 541, a second spool 542 and a second rope 543. The at least one second gear 541 is engaged with the at least one first gear 531. One of two ends of the second rope 543 is wrapped to the second spool 542, and the other one of the two ends of the second rope 542 passes through the second transition member 7 and the curtain 3, and is fixed to the second end of the top rail 1.

As shown in FIGS. 1 and 2, the first transition member 6 and the second transition member 7 are respectively located to two ends of the bottom rail 2. The first transition member 6 and the second transition member 7 have identical structure and are located symmetrically to each other. Each of the first transition member 6 and the second transition member 7 includes a first rod 61/71 and a second rod 62/72. The first rod 61/71 is perpendicular to the bottom rail 2. The second rod 62/72 is parallel to the bottom rail 2. The first/second rope 533/543 is wrapped to the first rod 61/71 and turns 90 degrees to be wrapped to the second rod 62/72, and the first/second rope 533/543 passes through the curtain 3 and is fixed to the top rail 1.

The top rail 1 is light and easily to be installed because the transmission unit 4, the scrolling unit 5, the first transition member 6 and the second transition member 7 are located in the bottom rail 2. In addition, the transmission unit 4 and the scrolling unit 5 are easily maintained in the bottom rail 2.

The curtain 3 can also be operated by the power from the rechargeable battery 441 when an electric power outage happens.

The control member 41 of the transmission unit 4 is controlled by a wireless remote controller (not shown) so as to activate the motor 42.

When in use, the shaft 43 drives the passive gear 52 of the scrolling unit 5, and the first part 53 and the second part 54 are co-rotated to scroll or release the first and second ropes 533, 543 to lift or lower the curtain 3. Besides, the scrolling unit 5 is transversely installed so that the first and second ropes 533, 543 are not likely entangled with other.

While we have shown and described the embodiment in accordance with the present invention, it should be clear to those skilled in the art that further embodiments may be made without departing from the scope of the present invention.

What is claimed is:

1. A window curtain comprising:
a top rail;
a bottom rail;
a curtain connected between the top rail 1 and the bottom rail;
a transmission unit located in the bottom rail and including a control member, a motor, and a shaft, the shaft connected to the motor, the control member controlling operation of the motor;
a scrolling unit located in the bottom rail and including a case in which a passive part, a first prat and a second part are accommodated, the passive part including a bevel gear and a spur gear which is co-rotated with the bevel gear, the shaft extending into the case and connected to a driving gear, the driving gear engaged with the bevel gear, the spur gear located beneath the bevel gear;
the first part including at least one first gear, a first spool and a first rope, the at least one first gear engaged with the spur gear, the first rope wrapped to the first spool, an end of the first rope passing through a first transition member and the curtain, and fixed to a first end of the top rail;
the second part including at least one second gear, a second spool and a second rope, the at least one second gear engaged with the at least one first gear, the second rope wrapped to the second spool, an end of the second rope passing through a second transition member and the curtain, and fixed to a second end of the top rail, and
the first transition member and the second transition member respectively located to two ends of the bottom rail, the first transition member and the second transition member having identical structure and located symmetrically to each other, each of the first transition member and the second transition member including a first rod and a second rod, the first rod being perpendicular to the bottom rail, the second rod being parallel to the bottom rail, the first/second rope wrapped to the first rod and turning 90 degrees to be wrapped to the second rod, and the first/second rope passing through the curtain and fixed to the top rail.

2. The window curtain as claimed in claim 1, wherein the transmission unit includes a power supply which is electrically connected to the motor.

3. The window curtain as claimed in claim 2, wherein the power supply includes a box and a rechargeable battery is received in the box.

4. The window curtain as claimed in claim 1, wherein the control member of the transmission unit is controlled by a wireless remote controller so as to activate the motor.

5. The window curtain as claimed in claim 1, wherein the bottom rail includes a bottom plate and a housing, the bottom pate is connected to the housing to form a room between the housing and the bottom plate, the transmission unit, the scrolling unit, the first transition member and the second transition member are located in the room between of the housing and the bottom plate.
